(19) United States
(12) Patent Application Publication
(10) Pub. No.: US 2026/0292561 A1
(43) Pub. Date: Sep. 24, 2026

(54) CONFIGURATION OF BEAM MEASUREMENT AND BEAM REPORT FOR AI BASED BEAM PREDICTION

(71) Applicant: LENOVO (BEIJING) LIMITED, Beijing (CN)

(72) Inventors: Bingchao Liu, Beijing (CN); Jianfeng Wang, Beijing (CN); Haiming Wang, Beijing (CN)

(21) Appl. No.: 18/996,193

(22) PCT Filed: Jul. 20, 2022
(86) PCT No.: PCT/CN2022/106827

§ 371 Date: Jan. 17, 2025

(51) Int. Cl. H04W 24/10; H04B 7/06; H04W 24/08

(52) U.S. Cl. CPC H04W 24/10; H04B 7/0626; H04W 24/08

(57) ABSTRACT

Methods and apparatuses for are disclosed. In one embodiment, a UE comprises a transceiver; and a processor coupled to the transceiver, wherein the processor is configured to report, via the transceiver, a set of parameters to define an AI/ML model for beam prediction; and receive, via the transceiver, a configuration for CSI report setting associated with the AI/ML model, wherein the CSI report setting is associated with one CSI resource setting for beam prediction and one CSI resource setting for beam measurement.

### FIELD

The subject matter disclosed herein generally relates to wireless communications, and more particularly relates to methods and apparatuses for configuration of beam measurement and beam report for AI based beam prediction.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Machine learning (ML), artificial intelligence (AI), base station (BS), Deep Neural Network (DNN), Recurrent Neural Network (RNN), Reference Signal Receiving Power (RSRP), Layer 1 Reference Signal Receiving Power (L1-RSRP), cyclic prefix (CP), Physical Downlink Control Channel (PDCCH), Channel State Information (CSI), Channel State Information Reference Signal (CSI-RS), subcarrier space (SCS), non-zero power (NZP), synchronization signal (SS), Physical Broadcast Channel (PBCH), SS/PBCH Block (SSB), medium access control (MAC), control element (CE), bandwidth part (BWP), quasi colocation (QCL), CSI-RS resource indicator (CRI).

Machine learning (ML) is a method to achieve artificial intelligence (AI). In the following description, they are described as AI/ML. AI/ML based beam prediction is studied in NR Release 18 for reduction of signaling overhead, especially for the case that larger number of beams are adopted for the base station (BS) and/or the UE. One potential use case is that an AI/ML function is deployed in a UE, and the UE can predict a beam in beam set A based on the measurement of beams in beam set B, where beam set A comprises of a larger number of beams while beam set B comprises of a small number of beams.

This invention targets support of such AI/ML based beam prediction.

### BRIEF SUMMARY

Methods and apparatuses for configuration of beam measurement and beam report for AI based beam prediction are disclosed.

In one embodiment, a UE comprises a transceiver; and a processor coupled to the transceiver, wherein the processor is configured to report, via the transceiver, a set of parameters to define an AI/ML model for beam prediction; and receive, via the transceiver, a configuration for CSI report setting associated with the AI/ML model, wherein the CSI report setting is associated with one CSI resource setting for beam prediction and one CSI resource setting for beam measurement.

In some embodiment, the parameters include: the number of beams configured in a measurement beam set for an input of the AI/ML model; the maximum number of beams that can be configured in a prediction beam set for beam prediction; the supported measurement beam construction mode; and an indication on whether additional AI/ML processing time for CSI computation is required for beam prediction. Additionally, if the indication indicates that additional AI/ML processing time for CSI computation is required for beam prediction, the parameters further include the additional AI/ML processing time for CSI computation.

In some embodiment, for an aperiodic CSI report for beam report associated with the AI/ML model for beam prediction, the following CSI computation timing requirements are satisfied: T_{proc, CSI, AI}=T_{proc, CSI}+T_{AI, CSI} is defined as the next UL symbol with its CP starting T_{proc, CSI, AI} after the end of the last symbol of the PDCCH triggering the CSI report containing beam report corresponding to an AI/ML based beam prediction; and T′_{proc, CSI, AI}=T′_{proc, CSI}+T′_{AI, CSI} is defined as the next UL symbol with its CP starting T′_{proc, CSI, AI} after the end of the last symbol in time of aperiodic CSI-RS for channel measurement when aperiodic CSI-RS is used for channel measurement for the triggered CSI report containing beam report corresponding to an AI/ML based beam prediction, where, T_{proc, CSI} and T′_{proc, CSI} are CSI computation time specified without AI/ML inference, and T_{AI, CSI} and T′_{AI, CSI} are reported by the UE if additional AI/ML processing time is required, and are 0 if additional AI/ML processing time is not required. Optionally, T_{AI, CSI} and T′_{AI, CSI} have the same value.

In some embodiment, if a measurement beam set indicated in the one CSI resource setting for beam measurement is a subset of a prediction beam set indicated in the one CSI resource setting for beam prediction, the measurement beam set is configured by a bitmap of the prediction beam set, each bit bᵢ of the bitmap indicates whether the (i+1)^{th} beam in the prediction beam set is indicated as a measurement beam, i is from 0 to the number of beams in the prediction beam set minus 1, and the number of bits of the bitmap indicating that the (i+1)^{th} beam in the prediction beam set is indicated as the measurement beam is equal to the number of beams in the measurement beam set. Optionally, the bitmap can be updated by a MAC CE. Further, the AI/ML model associated with the CSI report configuration can be updated by the MAC CE.

In some embodiment, if a measurement beam set indicated in the one CSI resource setting for beam measurement and a prediction beam set indicated in the one CSI resource setting for beam prediction are different beam sets, any beam in the prediction beam set is QCLed with one beam within the measurement beam set with respect to QCL-TypeC and QCL-TypeD.

In some embodiment, for an aperiodic CSI report for beam report associated with the AI/ML model for beam prediction, the predicted beam(s) reported in the beam report are selected from a prediction beam set indicated in the one CSI resource setting for beam prediction. In particular, the bit width of CRI field in the CSI report is determined by the number of beams contained in the beam prediction set, where CRI k (k≥0) corresponds to the configured (k+1)^{th} entry of the resources in the prediction beam set. In another embodiment, a method performed at a UE comprises reporting a set of parameters to define an AI/ML model for beam prediction; and receiving a configuration for CSI report setting associated with the AI/ML model, wherein the CSI report setting is associated with one CSI resource setting for beam prediction and one CSI resource setting for beam measurement.

In still another embodiment, a base unit comprises a transceiver; and a processor coupled to the transceiver, wherein the processor is configured to receive, via the transceiver, a set of parameters to define an AI/ML model for beam prediction; and transmit, via the transceiver, a configuration for CSI report setting associated with the AI/ML model, wherein the CSI report setting is associated with one CSI resource setting for beam prediction and one CSI resource setting for beam measurement.

In some embodiment, the parameters include: the number of beams configured in a measurement beam set for an input of the AI/ML model; the maximum number of beams that can be configured in a prediction beam set for beam prediction; the supported measurement beam construction mode; and an indication on whether additional AI/ML processing time for CSI computation is required for beam prediction. Additionally, if the indication indicates that additional AI/ML processing time for CSI computation is required for beam prediction, the parameters further include the additional AI/ML processing time for CSI computation.

In some embodiment, for an aperiodic CSI report for beam report associated with the AI/ML model for beam prediction, the following CSI computation timing requirements are satisfied: T_{proc, CSI, AI}=T_{proc, CSI}+T_{AI, CSI} is defined as the next UL symbol with its CP starting T_{proc, CSI, AI} after the end of the last symbol of the PDCCH triggering the CSI report containing beam report corresponding to an AI/ML based beam prediction; and T′_{proc, CSI, AI}=T′_{proc, CSI}+T′_{AI, CSI} is defined as the next UL symbol with its CP starting T′_{proc, CSI, AI} after the end of the last symbol in time of aperiodic CSI-RS for channel measurement when aperiodic CSI-RS is used for channel measurement for the triggered CSI report containing beam report corresponding to an AI/ML based beam prediction, where, T_{proc, CSI} and T′_{proc, CSI} are CSI computation time specified without AI/ML inference, and T_{AI, CSI} and T′_{AI, CSI} are reported by the UE if additional AI/ML processing time is required, and are 0 if additional AI/ML processing time is not required. Optionally, T_{AI, CSI} and T′_{AI, CSI} have the same value.

In some embodiment, if a measurement beam set indicated in the one CSI resource setting for beam measurement is a subset of a prediction beam set indicated in the one CSI resource setting for beam prediction, the measurement beam set is configured by a bitmap of the prediction beam set, each bit b; of the bitmap indicates whether the (i+1)^{th} beam in the prediction beam set is indicated as a measurement beam, i is from 0 to the number of beams in the prediction beam set minus 1, and the number of bits of the bitmap indicating that the (i+1)^{th} beam in the prediction beam set is indicated as the measurement beam is equal to the number of beams in the measurement beam set. Optionally, the bitmap can be updated by a MAC CE. Further, the AI/ML model associated with the CSI report configuration can be updated by the MAC CE.

In some embodiment, if a measurement beam set indicated in the one CSI resource setting for beam measurement and a prediction beam set indicated in the one CSI resource setting for beam prediction are different beam sets, any beam in the prediction beam set is QCLed with one beam within the measurement beam set with respect to QCL-TypeC and QCL-TypeD.

In some embodiment, for an aperiodic CSI report for beam report associated with the AI/ML model for beam prediction, the predicted beam(s) reported in the beam report are selected from a prediction beam set indicated in the one CSI resource setting for beam prediction. In particular, the bit width of CRI field in the CSI report is determined by the number of beams contained in the beam prediction set, where CRI k (k≥0) corresponds to the configured (k+1)^{th} entry of the resources in the prediction beam set. In yet another embodiment, a method performed at a base unit comprises receiving a set of parameters to define an AI/ML model for beam prediction; and transmitting a configuration for CSI report setting associated with the AI/ML model, wherein the CSI report setting is associated with one CSI resource setting for beam prediction and one CSI resource setting for beam measurement.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates the principle of AI/ML based beam prediction in spatial domain;

FIG. 2 illustrates two CSI processing time requirements with AI/ML model deployed;

FIG. 3 illustrates supported measurement beam construction Mode 1;

FIG. 4 illustrates supported measurement beam construction Mode 2;

FIG. 5 illustrates an example of the MAC CE for measurement beam set update;

FIG. 6 is a schematic flow chart diagram illustrating an embodiment of a method;

FIG. 7 is a schematic flow chart diagram illustrating an embodiment of another method; and

FIG. 8 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

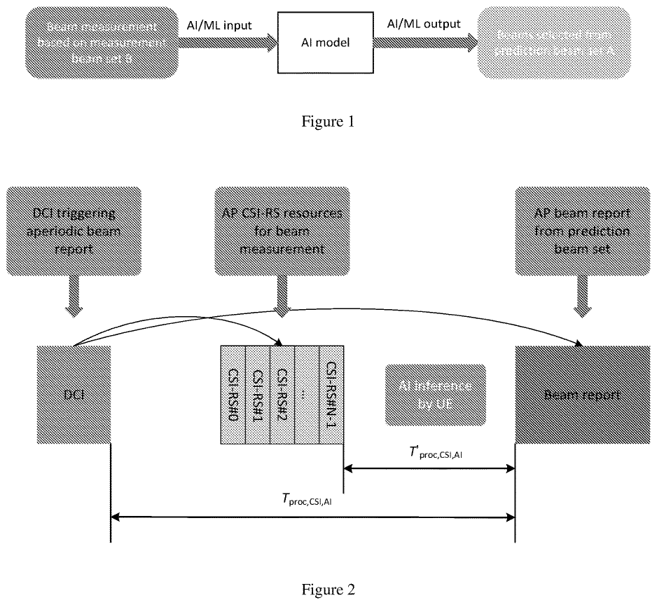

FIG. 1 illustrates the principle of AI/ML based beam prediction in spatial domain. An AI/ML model can be implemented by a Deep Neural Network (DNN) or a Recurrent Neural Network (RNN). As shown in FIG. 1, an AI/ML model which can be used for beam prediction based on AI/ML inference function is deployed at the UE or network (e.g. gNB) side. The measurement results (e.g., the L1-RSRP) based on the beam measurement set (e.g. beam measurement set B), which includes some number of beams, are set as the input of the AI/ML model. The AI/ML model, based on the input, according to AI/ML inference algorithm, performs beam prediction of another beam prediction set (e.g. beam prediction set A), which includes a larger number of beams. Incidentally, the output of the AI/ML model can be predicted results of any number of beams (e.g. 2 beams) contained in the beam prediction set.

This disclosure assumes that the AI/ML model is deployed at the UE side.

A first embodiment relates to UE capability(ies) related to AI/ML.

A first sub-embodiment of the first embodiment relates to the number of beams in a measurement beam set (e.g. AI/ML input) and the number of beams in a prediction beam set (e.g. AI/ML output).

As shown in FIG. 1, the input of the AI/ML model is the measurement results based on measurement beam set B, while the output of the AI/ML model is the predicted results of any numbers of the beams contained in prediction beam set A. It means that each AI/ML model has at least two parameters to be defined:
(1) Number of beams configured in the measurement beam set, and
(2) Maximum number of beams that can be configured in the prediction beam set.

For example, Table 1 illustrates examples of these two parameters for different AI/ML models.

TABLE 1

| | Number | Maximum |
|---|---|---|
| | (N_{M}) beams | number (N_{p,max}) |
| | configured | of beams that |
| | in the | can be configured |
| | measurement | in the prediction |
| AI/ML Model ID | beam set | beam set |
| AI/ML Model#1 | N_{M,1} | N_{p,max,1} |
| AI/ML Model#2 | N_{M,2} | N_{p,max,2} |
| AI/ML Model#3 | N_{M,3} | N_{p,max,3} |
| AI/ML Model#4 | N_{M,4} | N_{p,max,4} |

It means that when the UE reports or registers an AI/ML Model which can be used for beam prediction, the UE shall indicate the number (e.g. N_{M}) of measurement beams that shall be configured in measurement beam set to obtain the input of the AI/ML model, and the maximum number (e.g. N_{p,max}) of prediction beams that can be configured in the prediction beam set. So, for a CSI report for beam report, in which the UE reports one or more beams that can be used for the subsequent transmission, associated with this AI/ML Model, N_{M} measurement beams should be configured in the measurement beam set, and the number of prediction beams configured in prediction beam set shall be equal to or smaller than N_{p,max}.

Optionally, when the UE reports (1) the number of beams configured in measurement beam set and (2) the maximum number of beams configured in prediction beam set, other assistant information that can be set as the AI/ML input for this AI/ML Model can be additionally reported. For example, UE position information is an example of other assistant information that can be set as the AI/ML input.

A second sub-embodiment of the first embodiment relates to CSI processing capability considering the AI/ML model related process.

Traditionally (i.e. without AI/ML model), CSI computation time is specified in NR Release 15. Two CSI processing time requirements are defined as follows: T_{proc, CSI} is defined as the next UL symbol with its CP starting T_{proc, CSI} after the end of the last symbol of the PDCCH triggering the CSI report containing beam report; and T′_{proc, CSI} is defined as the next UL symbol with its CP starting T′_{proc, CSI} after the end of the last symbol in time of aperiodic CSI-RS for channel measurement when aperiodic CSI-RS is used for channel measurement for the triggered CSI report.

When the AI/ML model is deployed and used at UE side for a CSI computation, the AI/ML model takes additional time for AI/ML inference (i.e. the time duration necessary from receiving AI/ML inputs to providing AI/ML output). So, as shown in FIG. 2, two CSI processing time requirements can be similarly defined as follows: T_{proc, CSI, AI} is defined as the next UL symbol with its CP starting T_{proc, CSI, AI} after the end of the last symbol of the PDCCH triggering the CSI report containing beam report; and T′_{proc, CSI, AI} is defined as the next UL symbol with its CP starting T′_{proc, CSI, AI} after the end of the last symbol in time of aperiodic CSI-RS for channel measurement when aperiodic CSI-RS is used for channel measurement for the triggered CSI report containing beam report corresponding to an AI/ML based beam prediction.

Due to additional time for AI inference, T_{proc, CSI, AI} is larger than T_{proc, CSI} and T′_{proc, CSI, AI} is larger than T′_{proc, CSI}. It can be assumed that: T_{proc, CSI, AI}=T_{proc, CSI}+T_{AI, CSI} and T′_{proc, CSI}+T′_{AI, CSI}, where T_{AI, CSI} and T′_{AI, CSI} represent additional time for AI/ML inference for CSI computation. The values of T_{AI, CSI} and T′_{AI, CSI}, which can be collectively referred to as additional AI/ML processing time for CSI computation, are specific to AI/ML inference. It means that the values of T_{AI, CSI} and T′_{AI, CSI} for an AI/ML inference can be reported by the UE when one or more AI/ML Models are reported or registered. Alternatively, the values of T_{AI, CSI} and T′_{AI, CSI} for an AI/ML model can be configured by gNB when the AI/ML model is transferred from gNB to UE.

T_{AI, CSI} and T′_{AI, CSI} can be reported or be configured as a number of symbols corresponding to different SCSs per UE or per AI/ML Model or per AI/ML type (for example, AI/ML models for beam management or AI/ML models for CSI compression).

The AI/ML models for CSI compression may replace legacy CSI compressing model in some use cases. In other words, the AI/ML models for CSI compression do not predict beams. It means that the additional AI/ML processing time for CSI computation is not necessary for an AI/ML model for CSI compression. From another point of view, the additional AI/ML processing time for CSI computation, i.e. T_{AI, CSI} and T′_{AI, CSI} can be regarded as 0 for the AI/ML model for CSI compression.

In order to indicate the additional AI/ML processing time for CSI computation for both the AI/ML model for beam management and the AI/ML model for CSI compression, an indication on whether additional AI/ML processing time for CSI computation is necessary can be reported. In addition, if the additional AI/ML processing time for CSI computation is necessary (e.g. for the AI/ML model for beam management), the additional AI/ML processing time for CSI computation, i.e. T_{AI, CSI} and T′_{AI, CSI} are further reported. On the other hand, if the additional AI/ML processing time for CSI computation is not necessary (e.g. for the AI/ML model for CSI compression), it is unnecessary to further report the additional AI/ML processing time for CSI computation.

Optionally, T_{AI, CSI} and T′_{AI, CSI} can have the same value.

A third sub-embodiment of the first embodiment relates to supported measurement beam construction. Supported measurement beam construction means how the beam measurement set is constructed. Two alternative constructions are proposed:
Alternative 1: beam measurement set (i.e. set B) is a subset of prediction beam set (i.e. set A).
Alternative 2: beam measurement set (i.e. set B) and prediction beam set (i.e. set A) are different beam sets. For example, set A consists of narrow beams and set B consists of wide beams.

Both alternatives 1 and 2 can be used for beam prediction. One alternative can be referred to as Mode 1, and the other alternative can be referred to as Mode 2. In the following description, alternative 1 is referred to as Mode 1, and alternative 2 is referred to as Mode 2.

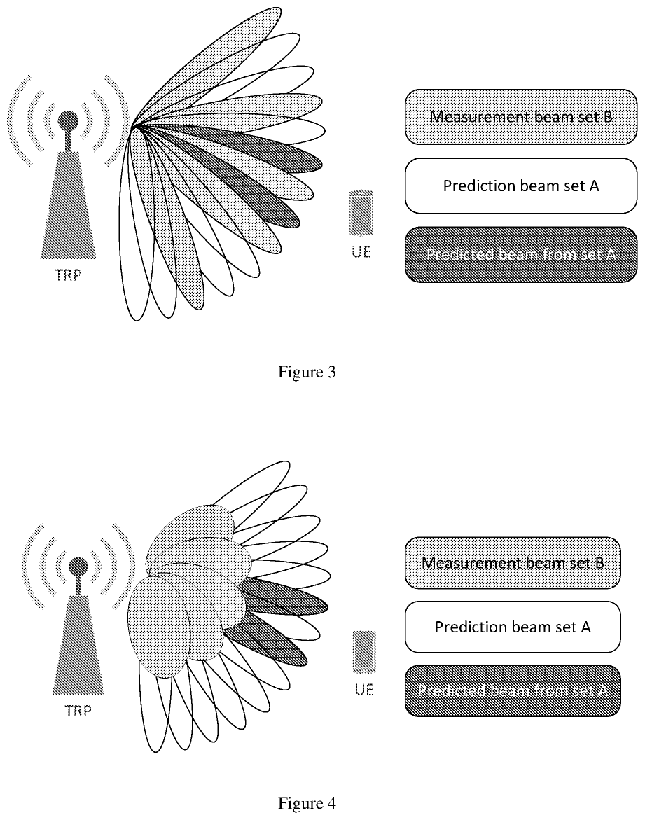

An example of supported measurement beam construction Mode 1 is illustrated in FIG. 3. All beams shown in FIG. 3 belong to prediction beam set A. The beams shown as solid belong to measurement beam set B, which is a subset of prediction beam set A. The two beams with grid are two predicted beams selected from the prediction beam set A, e.g. the two beams with the best qualities.

An example of supported measurement beam construction Mode 2 is illustrated in FIG. 4. All narrow beams belong to prediction beam set A. All wide beams belong to measurement beam set B. The prediction beam set A and the measurement beam set B include different beams. The two beams with grid are two predicted beams selected from the prediction beam set A, e.g. the two beams with the best qualities.

Different modes may correspond to different AI/ML inference algorithms and be further associated with different AI/ML models. Therefore, the UE shall report the required measurement beam construction (e.g. Mode 1 or Mode 2) for each AI/ML model.

As a whole, for each AI/ML model, the following parameters can be reported:
the number of beams configured in a measurement beam set for an input of the AI/ML model;
the maximum number of beams that can be configured in a prediction beam set;
the supported measurement beam construction mode; and
an indication on whether additional AI/ML processing time for CSI computation is required for beam prediction, where if the indication indicates that additional AI/ML processing time for CSI computation is required for beam prediction, the parameters further include the additional AI/ML processing time for CSI computation.

Incidentally, the parameters of multiple AI/ML Models can be reported together.

A second embodiment relates to CSI measurement and report configuration for beam prediction.

CSI framework based on CSI report configuration is reused for beam prediction. In particular, two resource settings, each of which is used to configure one or more resource sets for channel or interference measurement, are associated with a CSI report configuration (e.g. CSI-ReportConfig), one CSI resource setting is for measurement beam set configuration and the other CSI resource setting is for prediction beam configuration. An example of the CSI report configuration (CSI-ReportConfig) according to the second embodiment is provided as follows:

| CSI-ReportConfig::={ | |
|---|---|
| resourceForBeamPrediction | nzp-CSI-RS-ResourceSetId |
| resourceForBeamMeasurement | nzp-CSI-RS-ResourceSetId |
| associatedAiModel | ai-ModelId |
| reportQuantity | cri-RSRP |

}

resourceForBeamPrediction, which corresponds to the CSI resource setting for beam prediction, indicates an NZP CSI-RS resource set (e.g. with an nzp-CSI-RS-ResourceSetId) containing Np NZP CSI-RS resources, where each NZP CSI-RS resource correspond to a beam for prediction.

resourceForBeamMeasurement, which corresponds to the CSI resource setting for beam measurement, indicates another NZP CSI-RS resource set (e.g. with an nzp-CSI-RS-ResourceSetId) containing N_{M} NZP CSI-RS resources, where each NZP CSI-RS resource corresponds to a beam for measurement.

associatedAiModel indicates an AI/ML model associated with CSI report configuration for beam prediction.

reportQuantity can be set to cri-RSRP for a beam report.

In the above CSI report configuration, each of resourceForBeamPrediction and resourceForBeamMeasurement indicates an NZP CSI-RS resource set containing a number of NZP CSI-RS resources. Alternatively, any of resourceForBeamPrediction and resourceForBeamMeasurement may indicate an SSB resource set containing a number of SSB resources. It means that a CSI resource setting configures one or more CSI-RS resource sets or SSB resource sets for channel and/or interference measurement.

For simplification, in the following description, it is assumed that each of resourceForBeamPrediction and resourceForBeamMeasurement indicates an NZP CSI-RS resource set containing a number of NZP CSI-RS resources.

The predicted beam(s) reported in the beam report associated with the CSI report should be selected from resource set the NZP CSI-RS et configured for resourceForBeamPrediction. Therefore, the bit width of the CRI field in the CSI report is determined by the number of beams contained in the beam prediction set (e.g. determined by ┌log₂(Nₚ)┐). CRI k (k≥0) corresponds to the configured (k+1)^{th} entry of the NZP CSI-RS resources in the NZP CSI-RS resource set for beam prediction.

A third embodiment relates to configuring or determining the measurement beam set in Mode 1 (i.e. beam measurement set (i.e. set B) is a subset of prediction beam set (i.e. set A)).

The configuration of measurement beam set can be a bitmap corresponding to all the beams in the prediction beam set. Suppose that the prediction beam set includes Nₚ NZP CSI-RS sources. A bitmap with a length of Nₚ, e.g. bₙ (n=0 to Nₚ−1), i.e., b_{Np-1}, b_{Np-2}, . . . , b₁, b₀, is configured for resourceForBeamMeasurement, where bₙ can be set to ‘1’ or ‘0’ corresponding to that the (n+1)^{th} NZP CSI-RS resource in the NZP CSI-RS resource set for beam prediction is activated (i.e. selected) or deactivated (i.e. not selected) for measurement beam set. The number of bₙ set to ‘1’ is equal to N_{M}, i.e. the number of resources contained in the beam measurement set.

For example, a UE is configured with a CSI report configuration associated with an AI/ML model for beam prediction. The associated AI/ML model supports Mode 1. Further, the number of measurement beams for AI/ML model input (i.e. the number of beams contained in beam measurement set) is N_{M}=16, and the maximum number (N_{p,max}) of beams contained in prediction beam set is 128. The gNB configures a CSI report configuration (CSI-ReportConfig) for beam prediction, where the prediction beam set is associated with an NZP CSI-RS resource set containing Nₚ (=64, which is smaller than N_{p,max}) CSI-RS resources, e.g., NZP CSI-RS resource #0, NZP CSI-RS resource #1, . . . , NZP CSI-RS resource #63.

In this condition, the configuration of measurement beam set can be a bitmap with a length of 64 (=Nₚ) bits to indicate the beams contained in the beam measurement set. The number of bits in the 64-bits bitmap set to ‘1’ (i.e. indicating the (n+1)^{th} NZP CSI-RS resource in the NZP CSI-RS resource set for beam prediction is activated) shall be equal to N_{M}=16. For example, if 0001000100010001000100010001000100010001000100010001000100010001 is indicated by the bitmap, then the measurement beam set contains NZP CSI-RS resources #0, #4, #8, #12, #16, #20, #24, #28, #32, #36, #40, #44, #48, #52, #56, and #60.

If the beams contained in the beam measurement set need to be changed, e.g. when the scenario is changed, a MAC CE can be used to update the beams contained in the beam measurement set.

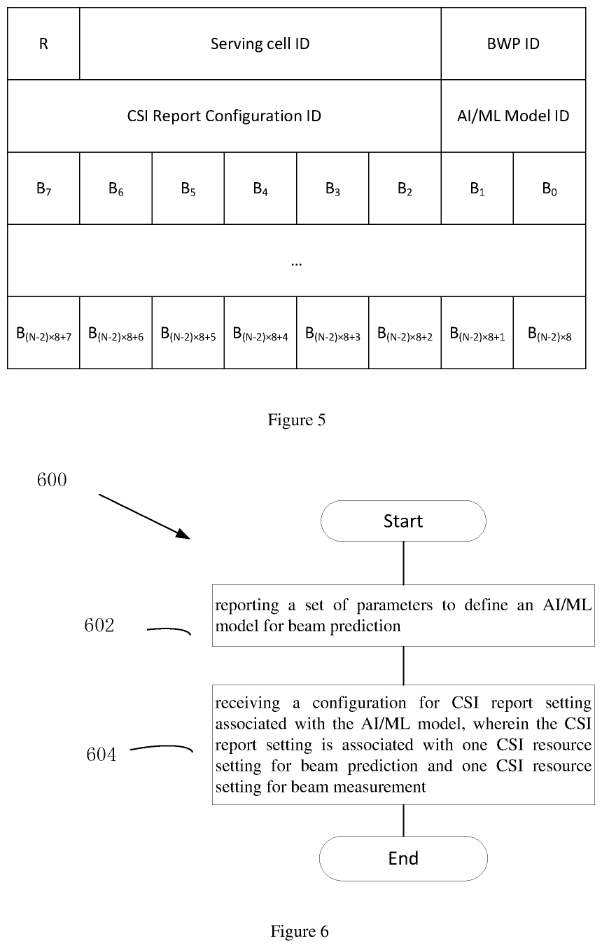

An example of the MAC CE for measurement beam set update for a CSI-ReportConfig is shown in FIG. 5.

In FIG. 5, the following fields are contained in the MAC CE:

Serving Cell ID (with 5 bits): the Serving Cell ID field indicates the identity of the Serving Cell for the MAC CE applies.

BWP ID (with 2 bits): the BWP ID field indicates a BWP of the cell indicated by the Serving Cell ID field for which the MAC CE applies.

CSI Report Configuration ID (with 6 bits by assuming that up to 64 CSI report configurations can be configured for a UE in a BWP of a serving cell): the CSI Report Configuration ID field indicates a CSI report configuration whose measurement beam set is updated.

AI/ML Model ID (with 2 bits by assuming that up to 4 AI/ML Models are registered by a UE): the AI/ML Model ID field indicates an AI/ML Model associated with the CSI report configuration indicated by CSI Report Configuration ID field.

Bᵢ: Bᵢ field indicates whether the (i+1)^{th} NZP CSI-RS resource contained in the NZP CSI-RS resource set indicated for the prediction beam set is activated (i.e. selected) or deactivated (i.e. not selected) for the measurement beam set. Bᵢ set to 0 indicates that the (i+1)^{th} beam in the prediction beam set is deactivated (i.e. not selected) for measurement beam, and Bᵢ set to 1 indicates that the (i+1)^{th} beam in the prediction beam set is activated (i.e. selected) for measurement beam. The number of Bᵢ fields is equal to the number of configured beams contained in the prediction beam set. For example, i=0 to (N−2)*8+7, where N is the smallest integer that satisfies (N−1)*16>=the number of configured beams contained in the prediction beam set.

If the AI/ML model ID contained in the MAC CE changes, the AI/ML model associated with the CSI report configuration indicated by the CSI report configuration ID field can be updated.

A fourth embodiment relates to configuring or determining the measurement beam set in Mode 2 (beam measurement set (i.e. set B) and prediction beam set (i.e. set A) are different beam sets).

In Mode 2, two different NZP CSI-RS resource sets are configured for resourceForBeamPrediction and resourceForBeamMeasurement, respectively. When the beams within measurement beam set are different from the beams within the prediction beam set, any of the NZP CSI-RS resources within the prediction beam set should be QCLed with an NZP CSI-RS resource or a SSB resource within the measurement beam set.

An example of Mode 2 is that wide beams (e.g. SSB beams) are used for beam measurement and narrow beams (e.g. TRS beams) are used for beam prediction, where each TRS within prediction beam set is QCLed with a SSB resource contained in the measurement beam set with respect to QCL-TypeC and QCL-TypeD, where QCL-TypeC: {Doppler shift, average delay}, and QCL-TypeD: {Spatial Rx parameter}.

FIG. 6 is a schematic flow chart diagram illustrating an embodiment of a method 600 according to the present application. In some embodiments, the method 600 is performed by an apparatus, such as a remote unit (e.g. UE). In certain embodiments, the method 600 may be performed by a processor executing program code, for example, a microcontroller, a microprocessor, a CPU, a GPU, an auxiliary processing unit, a FPGA, or the like.

The method 600 is a method performed at a UE, comprising: 602 reporting a set of parameters to define an AI/ML model for beam prediction; and 604 receiving a configuration for CSI report setting associated with the AI/ML model, wherein the CSI report setting is associated with one CSI resource setting for beam prediction and one CSI resource setting for beam measurement.

In some embodiment, the parameters include: the number of beams configured in a measurement beam set for an input of the AI/ML model; the maximum number of beams that can be configured in a prediction beam set for beam prediction; the supported measurement beam construction mode; and an indication on whether additional AI/ML processing time for CSI computation is required for beam prediction. Additionally, if the indication indicates that additional AI/ML processing time for CSI computation is required for beam prediction, the parameters further include the additional AI/ML processing time for CSI computation.

In some embodiment, for an aperiodic CSI report for beam report associated with the AI/ML model for beam prediction, the following CSI computation timing requirements are satisfied: T_{proc, CSI, AI}=T_{proc, CSI}+T_{AI, CSI} is defined as the next UL symbol with its CP starting T_{proc, CSI, AI} after the end of the last symbol of the PDCCH triggering the CSI report containing beam report corresponding to an AI/ML based beam prediction; and T′_{proc, CSI, AI}=T′_{proc, CSI}+T′_{AI, CSI} is defined as the next UL symbol with its CP starting T′_{proc, CSI, AI} after the end of the last symbol in time of aperiodic CSI-RS for channel measurement when aperiodic CSI-RS is used for channel measurement for the triggered CSI report containing beam report corresponding to an AI/ML based beam prediction, where, T_{proc, CSI} and T′_{proc, CSI} are CSI computation time specified without AI/ML inference, and T_{AI, CSI} and T′_{AI, CSI} are reported by the UE if additional AI/ML processing time is required, and are 0 if additional AI/ML processing time is not required. Optionally, T_{AI, CSI} and T′_{AI, CSI} have the same value.

In some embodiment, if a measurement beam set indicated in the one CSI resource setting for beam measurement is a subset of a prediction beam set indicated in the one CSI resource setting for beam prediction, the measurement beam set is configured by a bitmap of the prediction beam set, each bit bᵢ of the bitmap indicates whether the (i+1)^{th} beam in the prediction beam set is indicated as a measurement beam, i is from 0 to the number of beams in the prediction beam set minus 1, and the number of bits of the bitmap indicating that the (i+1)^{th} beam in the prediction beam set is indicated as the measurement beam is equal to the number of beams in the measurement beam set. Optionally, the bitmap can be updated by a MAC CE. Further, the AI/ML model associated with the CSI report configuration can be updated by the MAC CE.

In some embodiment, if a measurement beam set indicated in the one CSI resource setting for beam measurement and a prediction beam set indicated in the one CSI resource setting for beam prediction are different beam sets, any beam in the prediction beam set is QCLed with one beam within the measurement beam set with respect to QCL-TypeC and QCL-TypeD.

In some embodiment, for an aperiodic CSI report for beam report associated with the AI/ML model for beam prediction, the predicted beam(s) reported in the beam report are selected from a prediction beam set indicated in the one CSI resource setting for beam prediction. In particular, the bit width of CRI field in the CSI report is determined by the number of beams contained in the beam prediction set, where CRI k (k≥0) corresponds to the configured (k+1)^{th} entry of the resources in the prediction beam set.

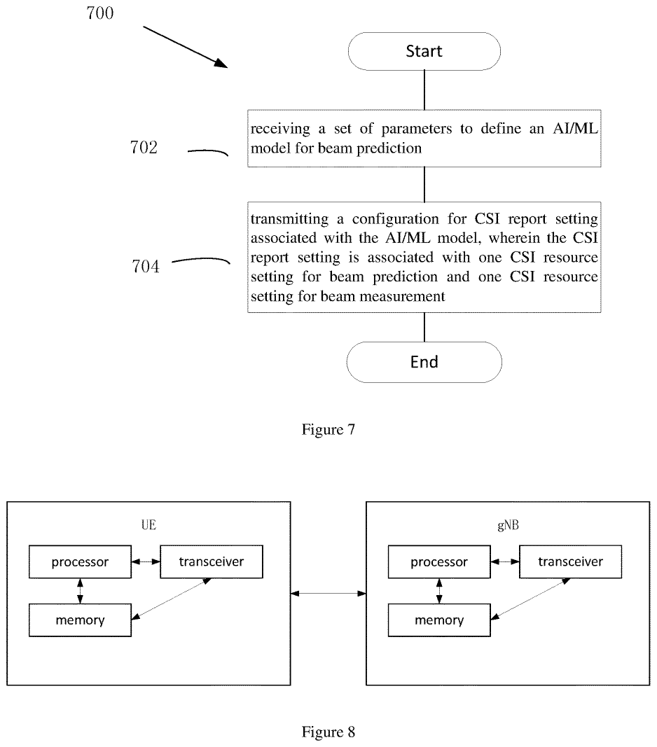

FIG. 7 is a schematic flow chart diagram illustrating an embodiment of a method 700 according to the present application. In some embodiments, the method 700 is performed by an apparatus, such as a base unit. In certain embodiments, the method 700 may be performed by a processor executing program code, for example, a microcontroller, a microprocessor, a CPU, a GPU, an auxiliary processing unit, a FPGA, or the like.

The method 700 may comprise 702 receiving a set of parameters to define an AI/ML model for beam prediction; and 704 transmitting a configuration for CSI report setting associated with the AI/ML model, wherein the CSI report setting is associated with one CSI resource setting for beam prediction and one CSI resource setting for beam measurement.

In some embodiment, the parameters include: the number of beams configured in a measurement beam set for an input of the AI/ML model; the maximum number of beams that can be configured in a prediction beam set for beam prediction; the supported measurement beam construction mode; and an indication on whether additional AI/ML processing time for CSI computation is required for beam prediction. Additionally, if the indication indicates that additional AI/ML processing time for CSI computation is required for beam prediction, the parameters further include the additional AI/ML processing time for CSI computation.

In some embodiment, for an aperiodic CSI report for beam report associated with the AI/ML model for beam prediction, the following CSI computation timing requirements are satisfied: T_{proc, CSI, AI}=T_{proc, CSI}+T_{AI, CSI} is defined as the next UL symbol with its CP starting T_{proc, CSI, AI} after the end of the last symbol of the PDCCH triggering the CSI report containing beam report corresponding to an AI/ML based beam prediction; and T′_{proc, CSI, AI}=T′_{proc, CSI}+T′_{AI, CSI} is defined as the next UL symbol with its CP starting T′_{proc, CSI, AI} after the end of the last symbol in time of aperiodic CSI-RS for channel measurement when aperiodic CSI-RS is used for channel measurement for the triggered CSI report containing beam report corresponding to an AI/ML based beam prediction, where, T_{proc, CSI} and T′_{proc, CSI} are CSI computation time specified without AI/ML inference, and T_{AI, CSI} and T′_{AI, CSI} are reported by the UE if additional AI/ML processing time is required, and are 0 if additional AI/ML processing time is not required. Optionally, T_{AI, CSI} and T′_{AI, CSI} have the same value.

In some embodiment, if a measurement beam set indicated in the one CSI resource setting for beam measurement is a subset of a prediction beam set indicated in the one CSI resource setting for beam prediction, the measurement beam set is configured by a bitmap of the prediction beam set, each bit bᵢ of the bitmap indicates whether the (i+1)^{th} beam in the prediction beam set is indicated as a measurement beam, i is from 0 to the number of beams in the prediction beam set minus 1, and the number of bits of the bitmap indicating that the (i+1)^{th} beam in the prediction beam set is indicated as the measurement beam is equal to the number of beams in the measurement beam set. Optionally, the bitmap can be updated by a MAC CE. Further, the AI/ML model associated with the CSI report configuration can be updated by the MAC CE.

In some embodiment, if a measurement beam set indicated in the one CSI resource setting for beam measurement and a prediction beam set indicated in the one CSI resource setting for beam prediction are different beam sets, any beam in the prediction beam set is QCLed with one beam within the measurement beam set with respect to QCL-TypeC and QCL-TypeD.

In some embodiment, for an aperiodic CSI report for beam report associated with the AI/ML model for beam prediction, the predicted beam(s) reported in the beam report are selected from a prediction beam set indicated in the one CSI resource setting for beam prediction. In particular, the bit width of CRI field in the CSI report is determined by the number of beams contained in the beam prediction set, where CRI k (k≥0) corresponds to the configured (k+1)^{th} entry of the resources in the prediction beam set.

FIG. 8 is a schematic block diagram illustrating apparatuses according to one embodiment.

Referring to FIG. 8, the UE (i.e. the remote unit) includes a processor, a memory, and a transceiver. The processor implements a function, a process, and/or a method which are proposed in FIG. 6.

The UE comprises a transceiver; and a processor coupled to the transceiver, wherein the processor is configured to report, via the transceiver, a set of parameters to define an AI/ML model for beam prediction; and receive, via the transceiver, a configuration for CSI report setting associated with the AI/ML model, wherein the CSI report setting is associated with one CSI resource setting for beam prediction and one CSI resource setting for beam measurement.

In some embodiment, the parameters include: the number of beams configured in a measurement beam set for an input of the AI/ML model; the maximum number of beams that can be configured in a prediction beam set for beam prediction; the supported measurement beam construction mode; and an indication on whether additional AI/ML processing time for CSI computation is required for beam prediction. Additionally, if the indication indicates that additional AI/ML processing time for CSI computation is required for beam prediction, the parameters further include the additional AI/ML processing time for CSI computation.

In some embodiment, for an aperiodic CSI report for beam report associated with the AI/ML model for beam prediction, the following CSI computation timing requirements are satisfied: T_{proc, CSI, AI}=T_{proc, CSI}+T_{AI, CSI} is defined as the next UL symbol with its CP starting T_{proc, CSI, AI} after the end of the last symbol of the PDCCH triggering the CSI report containing beam report corresponding to an AI/ML based beam prediction; and T′_{proc, CSI, AI}=T′_{proc, CSI}+T′_{AI, CSI} is defined as the next UL symbol with its CP starting T′_{proc, CSI, AI} after the end of the last symbol in time of aperiodic CSI-RS for channel measurement when aperiodic CSI-RS is used for channel measurement for the triggered CSI report containing beam report corresponding to an AI/ML based beam prediction, where, T_{proc, CSI} and T′_{proc, CSI} are CSI computation time specified without AI/ML inference, and T_{AI, CSI} and T′_{AI, CSI} are reported by the UE if additional AI/ML processing time is required, and are 0 if additional AI/ML processing time is not required. Optionally, T_{AI, CSI} and T′_{AI, CSI} have the same value.

In some embodiment, if a measurement beam set indicated in the one CSI resource setting for beam measurement is a subset of a prediction beam set indicated in the one CSI resource setting for beam prediction, the measurement beam set is configured by a bitmap of the prediction beam set, each bit bᵢ of the bitmap indicates whether the (i+1)^{th} beam in the prediction beam set is indicated as a measurement beam, i is from 0 to the number of beams in the prediction beam set minus 1, and the number of bits of the bitmap indicating that the (i+1)^{th} beam in the prediction beam set is indicated as the measurement beam is equal to the number of beams in the measurement beam set. Optionally, the bitmap can be updated by a MAC CE. Further, the AI/ML model associated with the CSI report configuration can be updated by the MAC CE.

In some embodiment, if a measurement beam set indicated in the one CSI resource setting for beam measurement and a prediction beam set indicated in the one CSI resource setting for beam prediction are different beam sets, any beam in the prediction beam set is QCLed with one beam within the measurement beam set with respect to QCL-TypeC and QCL-TypeD.

In some embodiment, for an aperiodic CSI report for beam report associated with the AI/ML model for beam prediction, the predicted beam(s) reported in the beam report are selected from a prediction beam set indicated in the one CSI resource setting for beam prediction. In particular, the bit width of CRI field in the CSI report is determined by the number of beams contained in the beam prediction set, where CRI k (k≥0) corresponds to the configured (k+1)^{th} entry of the resources in the prediction beam set.

The gNB (i.e. the base unit) includes a processor, a memory, and a transceiver. The processor implements a function, a process, and/or a method which are proposed in FIG. 7.

The base unit comprises a transceiver; and a processor coupled to the transceiver, wherein the processor is configured to receive, via the transceiver, a set of parameters to define an AI/ML model for beam prediction; and transmit, via the transceiver, a configuration for CSI report setting associated with the AI/ML model, wherein the CSI report setting is associated with one CSI resource setting for beam prediction and one CSI resource setting for beam measurement.

In some embodiment, the parameters include: the number of beams configured in a measurement beam set for an input of the AI/ML model; the maximum number of beams that can be configured in a prediction beam set for beam prediction; the supported measurement beam construction mode; and an indication on whether additional AI/ML processing time for CSI computation is required for beam prediction. Additionally, if the indication indicates that additional AI/ML processing time for CSI computation is required for beam prediction, the parameters further include the additional AI/ML processing time for CSI computation.

In some embodiment, for an aperiodic CSI report for beam report associated with the AI/ML model for beam prediction, the following CSI computation timing requirements are satisfied: T_{proc, CSI, AI}=T_{proc, CSI}+T_{AI, CSI} is defined as the next UL symbol with its CP starting T_{proc, CSI, AI} after the end of the last symbol of the PDCCH triggering the CSI report containing beam report corresponding to an AI/ML based beam prediction; and T′_{proc, CSI, AI}=T′_{proc, CSI}+T′_{AI, CSI} is defined as the next UL symbol with its CP starting T′_{proc, CSI, AI} after the end of the last symbol in time of aperiodic CSI-RS for channel measurement when aperiodic CSI-RS is used for channel measurement for the triggered CSI report containing beam report corresponding to an AI/ML based beam prediction, where, T_{proc, CSI} and T′_{proc, CSI} are CSI computation time specified without AI/ML inference, and T_{AI, CSI} and T′_{AI, CSI} are reported by the UE if additional AI/ML processing time is required, and are 0 if additional AI/ML processing time is not required. Optionally, T_{AI, CSI} and T′_{AI, CSI} have the same value.

In some embodiment, if a measurement beam set indicated in the one CSI resource setting for beam measurement is a subset of a prediction beam set indicated in the one CSI resource setting for beam prediction, the measurement beam set is configured by a bitmap of the prediction beam set, each bit bᵢ of the bitmap indicates whether the (i+1)^{th} beam in the prediction beam set is indicated as a measurement beam, i is from 0 to the number of beams in the prediction beam set minus 1, and the number of bits of the bitmap indicating that the (i+1)^{th} beam in the prediction beam set is indicated as the measurement beam is equal to the number of beams in the measurement beam set. Optionally, the bitmap can be updated by a MAC CE. Further, the AI/ML model associated with the CSI report configuration can be updated by the MAC CE.

In some embodiment, if a measurement beam set indicated in the one CSI resource setting for beam measurement and a prediction beam set indicated in the one CSI resource setting for beam prediction are different beam sets, any beam in the prediction beam set is QCLed with one beam within the measurement beam set with respect to QCL-TypeC and QCL-TypeD.

In some embodiment, for an aperiodic CSI report for beam report associated with the AI/ML model for beam prediction, the predicted beam(s) reported in the beam report are selected from a prediction beam set indicated in the one CSI resource setting for beam prediction. In particular, the bit width of CRI field in the CSI report is determined by the number of beams contained in the beam prediction set, where CRI k (k≥0) corresponds to the configured (k+1)^{th} entry of the resources in the prediction beam set.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
report a set of parameters to define an artificial intelligence (AI)/machine learning (ML) model for beam prediction; and
receive a configuration for a channel state information (CSI) report setting associated with the AI/ML model, wherein the CSI report setting is associated with one CSI resource setting for beam prediction and one CSI resource setting for beam measurement.

2. The UE of claim 1, wherein, the parameters include:
a number of beams configured in a measurement beam set for an input of the AI/ML model;
the maximum number of beams that can be configured in a prediction beam set for beam prediction;
a supported measurement beam construction mode; and
an indication on whether additional AI/ML processing time for CSI computation is required for beam prediction.

3. The UE of claim 2, wherein, if the indication indicates that additional AI/ML processing time for CSI computation is required for beam prediction, the parameters further include the additional AI/ML processing time for CSI computation.

4. The UE of claim 1, wherein, for an aperiodic CSI report for beam report associated with the AI/ML model for beam prediction, the following CSI computation timing requirements are satisfied:
T_{proc, CSI, AI}=T_{proc, CSI}+T_{AI, CSI} is defined as a next UL symbol with its CP starting T_{proc, CSI, AI} after an end of the last symbol of a physical downlink control channel (PDCCH) triggering the CSI report containing beam report corresponding to an AI/ML based beam prediction; and
T′_{proc, CSI, AI}=T′_{proc, CSI}+T′_{AI, CSI} is defined as the next UL symbol with its CP starting T′_{proc, CSI, AI} after the end of the last symbol in time of aperiodic CSI-reference signal (RS) for channel measurement when aperiodic CSI-RS is used for channel measurement for the triggered CSI report containing beam report corresponding to an AI/ML based beam prediction,
where, T_{proc, CSI} and T′_{proc, CSI} are CSI computation time specified without AI/ML inference, and T_{AI, CSI} and T′_{AI, CSI} are reported by the UE if additional AI/ML processing time is required, and are 0 if additional AI/ML processing time is not required.

5. The UE of claim 4, wherein, T_{AI, CSI} and T′_{AI, CSI} have the same value.

6. The UE of claim 1, wherein, if a measurement beam set indicated in the one CSI resource setting for beam measurement is a subset of a prediction beam set indicated in the one CSI resource setting for beam prediction, the measurement beam set is configured by a bitmap of the prediction beam set, each bit bᵢ of the bitmap indicates whether an (i+1)^{th} beam in the prediction beam set is indicated as a measurement beam, i is from 0 to a number of beams in the prediction beam set minus 1, and a number of bits of the bitmap indicating that the (i+1)^{th} beam in the prediction beam set is indicated as the measurement beam is equal to the number of beams in the measurement beam set.

7. The UE of claim 6, wherein, the bitmap can be updated by a medium access control (MAC) control element (CE).

8. The UE of claim 7, wherein, the AI/ML model associated with the CSI report configuration can be updated by the MAC CE.

9. The UE of claim 1, wherein, if a measurement beam set indicated in the one CSI resource setting for beam measurement and a prediction beam set indicated in the one CSI resource setting for beam prediction are different beam sets, any beam in the prediction beam set is quasi co-located (QCLed) with one beam within the measurement beam set with respect to QCL-TypeC and QCL-TypeD.

10. The UE of claim 1, wherein, for an aperiodic CSI report for beam report associated with the AI/ML model for beam prediction, the predicted beam(s) reported in the beam report are selected from a prediction beam set indicated in the one CSI resource setting for beam prediction.

11. The UE of claim 10, wherein, a bit width of a CSI-reference signal (RS) resource indicator (CRI) field in the CSI report is determined by a number of beams contained in the beam prediction set, where CRI k (k≥0) corresponds to a configured (k+1)^{th} entry of the resources in the prediction beam set.

12. A method performed by a user equipment (UE), the method comprising:
reporting a set of parameters to define an artificial intelligence (AI)/machine learning (ML) model for beam prediction; and
receiving a configuration for a channel state information (CSI) report setting associated with the AI/ML model, wherein the CSI report setting is associated with one CSI resource setting for beam prediction and one CSI resource setting for beam measurement.

13. A base station unit, comprising:
at least one memory; and
at least one processor coupled with the at least one memory and configured to cause the base station to:
receive a set of parameters to define an artificial intelligence (AI)/machine learning (ML) model for beam prediction; and
transmit a configuration for a channel state information (CSI) report setting associated with the AI/ML model, wherein the CSI report setting is associated with one CSI resource setting for beam prediction and one CSI resource setting for beam measurement.

14. A processor for wireless communication, comprising:
at least one controller coupled with at least one memory and configured to cause the processor to:
report a set of parameters to define an artificial intelligence (AI)/machine learning (ML) model for beam prediction; and
receive a configuration for a channel state information (CSI) report setting associated with the AI/ML model, wherein the CSI report setting is associated with one CSI resource setting for beam prediction and one CSI resource setting for beam measurement.

15. The processor of claim 14, wherein, the parameters include:
a number of beams configured in a measurement beam set for an input of the AI/ML model;
the maximum number of beams that can be configured in a prediction beam set for beam prediction;
a supported measurement beam construction mode; and
an indication on whether additional AI/ML processing time for CSI computation is required for beam prediction.

16. The processor of claim 15, wherein, if the indication indicates that additional AI/ML processing time for CSI computation is required for beam prediction, the parameters further include the additional AI/ML processing time for CSI computation.

17. The processor of claim 14, wherein, for an aperiodic CSI report for beam report associated with the AI/ML model for beam prediction, the following CSI computation timing requirements are satisfied:
T_{proc, CSI, AI}=T_{proc, CSI}+T_{AI, CSI} is defined as a next UL symbol with its CP starting T_{proc, CSI, AI} after an end of the last symbol of a physical downlink control channel (PDCCH) triggering the CSI report containing beam report corresponding to an AI/ML based beam prediction; and
T′_{proc, CSI, AI}=T′_{proc, CSI}+T′_{AI, CSI} is defined as the next UL symbol with its CP starting T′_{proc, CSI, AI} after the end of the last symbol in time of aperiodic CSI-reference signal (RS) for channel measurement when aperiodic CSI-RS is used for channel measurement for the triggered CSI report containing beam report corresponding to an AI/ML based beam prediction,
where, T_{proc, CSI} and T′_{proc, CSI} are CSI computation time specified without AI/ML inference, and
T_{AI, CSI} and T′_{AI, CSI} are reported by the processor if additional AI/ML processing time is required, and are 0 if additional AI/ML processing time is not required.

18. The processor of claim 17, wherein, T_{AI, CSI} and T′_{AI, CSI} have the same value.

19. The processor of claim 14, wherein, if a measurement beam set indicated in the one CSI resource setting for beam measurement is a subset of a prediction beam set indicated in the one CSI resource setting for beam prediction, the measurement beam set is configured by a bitmap of the prediction beam set, each bit bᵢ of the bitmap indicates whether an (i+1)^{th} beam in the prediction beam set is indicated as a measurement beam, i is from 0 to a number of beams in the prediction beam set minus 1, and a number of bits of the bitmap indicating that the (i+1)^{th} beam in the prediction beam set is indicated as the measurement beam is equal to the number of beams in the measurement beam set.

20. The processor of claim 19, wherein, the bitmap can be updated by a medium access control (MAC) control element (CE).
